(19) United States
(12) Patent Application Publication
(10) Pub. No.: US 2011/0089253 A1
(43) Pub. Date: Apr. 21, 2011

(54) Fluid Spray Device and Methods of Use

(76) Inventor: John Moorman, Littleton, CO (US)

(21) Appl. No.: 12/581,601

(22) Filed: Oct. 19, 2009

(51) Int. Cl. B05B 7/24; B05B 17/04

(52) U.S. Cl. 239/11; 239/337

(57) ABSTRACT

A fluid spray device adapted to use compressed gas to discharge a fluid is described. Embodiments of the device comprise a tank containing a fluid under positive pressure, and a wand through which the pressurized fluid is discharged. The device is typically operationally coupled to a truck pneumatic system to pressurize the fluid.

### FIELD OF THE INVENTION

The present invention relates generally to fluid spray devices comprising pressurized tanks and spray nozzles. The invention typically uses a vehicle mounted compressor to pressurize the tank, from which is dispensed a cleaning liquid.

### BACKGROUND

Washing large vehicles such as heavy duty trucks, tractor trailer rigs, and recreational vehicles, presents challenges. The large vehicles are often too large to use commercial car wash facilities adapted to washing passenger cars and light duty trucks, thus requiring specialized truck wash facilities that can be relatively scarce compared to ordinary car washes. In addition to disadvantage created by their relative scarcity, specialized truck wash facilities are relatively expensive compared to car washes.

Specialized truck wash facilities are sometimes indispensable. Where a large vehicle is especially dirty or otherwise due for a complete cleaning, a specialized truck wash facility offers substantial advantage for washing the large vehicle. However, in many instances a user may wish to wash his or her large vehicle under circumstances where the disadvantages of specialized truck wash facilities, such as relative scarcity and expense, outweigh the advantages. Moreover, under some circumstances a user may find disadvantage in having to use any commercial washing facility, be it a specialized truck wash facility or a common car wash.

For instance, a driver may wish to clean his or her large vehicle when the vehicle is located many miles, if not hundreds of miles, from the nearest wash facility. Similarly, a driver may not need to wash his or her entire vehicle, but may want to clean just the cab, which may not justify traveling to a wash facility.

Finally, a driver may sometimes wish to clean all or part of his or her vehicle when the driver is far from home or otherwise does not have ready access to a hose and water tap for washing or hosing down his vehicle.

### BRIEF DESCRIPTION OF THE DRAWINGS

FIG. 1 is a perspective view of a fluid spray device according to one embodiment of the present invention.

FIG. 2 is a side, plan view of a fluid spray device according to one embodiment of the present invention.

FIG. 3 is a perspective view of a fluid spray device according to one embodiment of the present invention.

### DETAILED DESCRIPTION

Embodiments of the present invention include a fluid spray device comprising a pressurized tank or vessel, a wand for dispensing liquid, and a hose connecting the wand to the tank. In typical operation, the tank contains an aqueous liquid, as well as gas under positive pressure, but the fluid spray device itself typically does not include gas compression means. The lack of gas compression means can result in a relatively light weight, portable, device. The gas is typically air, provided by an air compressor mounted in or on a heavy duty truck, tractor, recreational vehicle, or other large vehicle. The gas under positive pressure forces liquid out of the tank, through a hose to the wand, and the liquid is discharged through a wand outlet or nozzle. The wand typically, but not necessarily, comprises an additive reservoir containing a substance that is added to the water as it flows through the wand and is dispensed therefrom.

Many large vehicles have on-board air compressors for operating air brakes or other pneumatic devices, and embodiments of the fluid spray device rely on such on-board compressors to provide air under positive pressure, abrogating a need for a compressor dedicated to operation of the fluid spray device. Accordingly, the fluid spray device is adapted to ready portage because its mobility is not impeded by bulk and mass of a compressor.

The fluid spray device dispenses fluid across a broad range of pressures and flow rates, and can dispense a mild spray of liquid or a powerful high pressure spray. A relatively mild spray may be useful for applications such as, but not limited to, cleaning an inside of a vehicle.

The dispensed liquid is typically water or similar aqueous liquid that is contained in the device tank prior to dispensation. Distilled or deionized water can be used to reduce or eliminate dispensation and deposition of dissolved solids; water spots can thus be reduced or eliminated. A washing operation using an embodiment of the spray device can be performed using relatively little water. Accordingly, a gallon or two of water purchased at a gas station or convenience store may be adequate for some washing operations. A water tap is thus not required for operating the fluid spray device.

The device is also adapted to use without liquid in the tank, thereby generating a stream of air or other gas. Such gas can be used to blow away dust, or to blow water from a surface in order to hasten drying or reduce water spotting. For instance, a stream of air may be useful to blow dust and debris away from an air filter housing prior to opening the housing to service the air filter. Similarly, a stream of air may be used to blow residual water from a windshield or mirror after cleaning, thereby reducing spotting or streaking that could impair visibility.

### Terminology

The terms and phrases as indicated in quotation marks (“ ”) in this section are intended to have the meaning ascribed to them in this Terminology section applied to them throughout this document, including in the claims, unless clearly indicated otherwise in context. Further, as applicable, the stated definitions are to apply, regardless of the word or phrase's case, to the singular and plural variations of the defined word or phrase.

The term “or” as used in this specification and the appended claims is not meant to be exclusive; rather the term is inclusive, meaning either or both.

References in the specification to “one embodiment”, “an embodiment”, “another embodiment, “a preferred embodiment”, “an alternative embodiment”, “one variation”, “a variation” and similar phrases mean that a particular feature, structure, or characteristic described in connection with the embodiment or variation, is included in at least an embodiment or variation of the invention. The phrase “in one embodiment”, “in one variation” or similar phrases, as used in various places in the specification, are not necessarily meant to refer to the same embodiment or the same variation.

The term “couple” or “coupled” as used in this specification and appended claims refers to an indirect or direct physical connection between the identified elements, components, or objects. Often the manner of the coupling will be related specifically to the manner in which the two coupled elements interact.

The term “directly coupled” or “coupled directly,” as used in this specification and appended claims, refers to a physical connection between identified elements, components, or objects, in which no other element, component, or object resides between those identified as being directly coupled.

The term “about,” as used in this specification and appended claims, refers to plus or minus 20% of the value given.

The terms “positive pressure,” “positive air pressure,” “positive gas pressure,” “gas under positive pressure,” and similar terms, as used in this specification and appended claims, refers to gas pressure above atmospheric pressure. The atmospheric pressure used for reference is that surrounding a portable spray device. Atmospheric pressure at or near a surface of the earth is typically about 760 torr and varies with altitude, humidity, temperature, and other variables.

The term “reservoir substance,” as used in this specification and appended claims, refers to a composition of matter in fluid state or other physical state that will flow under pressure or gravity. Reservoir substances include gasses, liquids, plasmas, granular solids, gels, and super-critical fluids. Typical reservoir substances include waxes, degreasing agents, and surfactants such as, but not limited to, soaps, detergents, and rinsing agents. The term reservoir substance does not refer to air.

The terms “fitting” or “fittings,” as used in this specification and appended claims, refers generally to a small part that is one of a pair of complementary parts that are adapted to mate together to form a coupler. Except for glad hand fittings, the term fittings as used here refer generally to male or female quick release fittings, a male-female pair of fittings forming a quick release coupler. Glad hand fittings are quick release fittings that are not male or female, but are nevertheless complementary and combine in pairs to form glad hand couplers.

The term “mate” or “mating,” as used in this specification and appended claims, refers to combining complementary quick disconnect fittings to form a fitting pair referred to as a coupler. For instance, a male quick release pneumatic fitting is installed in, inserted into, or paired with a complementary female quick release pneumatic fitting to create a quick release coupler.

The terms “operationally couple” or “operationally coupled,” as used in this specification and appended claims, refers to a functional connection between identified elements, components, or objects, such that the operationally coupled elements, components, or objects require the functional connection in order to execute part or all of their function.

The term “gas compression means,” as used in this specification and appended claims, refers to an apparatus or component thereof that is adapted to compress gas or otherwise produce gas at a pressure substantially above atmospheric pressure. Gas compression means include compressors, pumps, hand pumps, diaphragm pumps, impellers, and rotary pumps.

The term “fluid” or “fluids,” as used in this specification and appended claims, refers to a continuous, amorphous substance whose molecules move freely past one another and that has the tendency to assume the shape of its container. Gases and liquids are typical fluids.

The term “fluid path,” as used in this specification and appended claims, refers to a space within which a fluid is contained and within the fluid can flow or move relatively unimpeded. Typical fluid paths include hoses, tubes, pipes, and lines. All parts of a fluid path are capable of being in fluid communication. A fluid path may be transiently blocked by a valve that interrupts fluid communication within the fluid path.

### A First Embodiment Fluid Spray Device

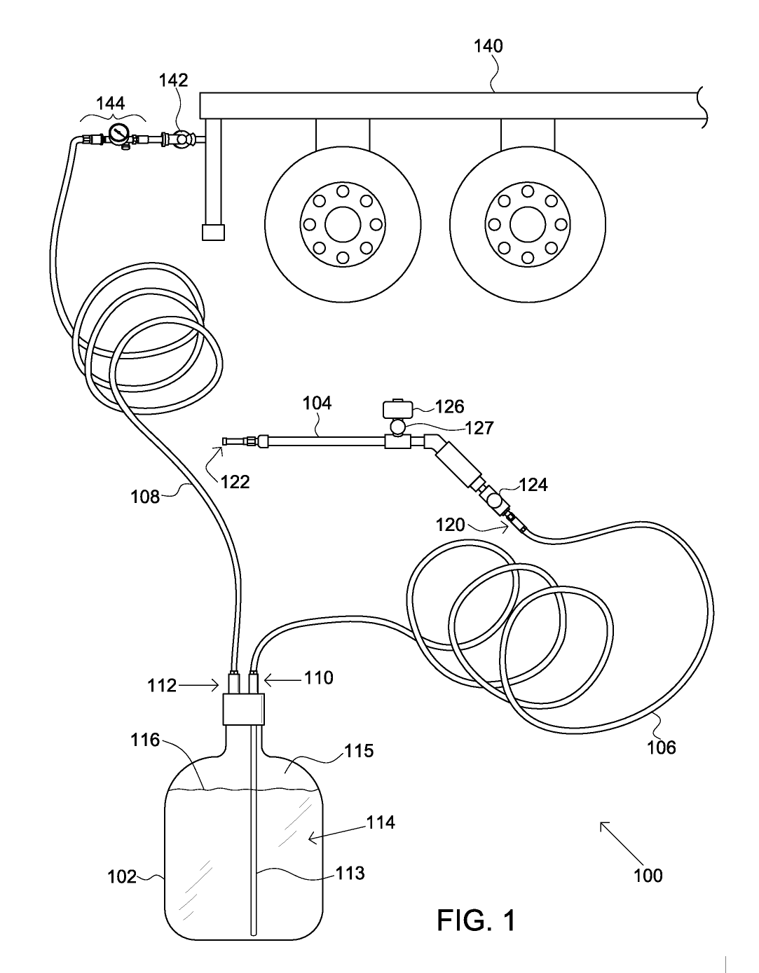

A first embodiment fluid spray device 100 is illustrated in FIG. 1. The first embodiment fluid spray device comprises a tank 102, a wand 104, a first hose 106, and a second hose 108. The tank comprises a polyethylene terephthalate shell and is adapted to hold about 90 pounds per square inch (psi) gas pressure in a tank inner cavity 114. The tank inner cavity has a volume of about 20 liters. Other embodiments of the fluid spray device comprise tank inner cavities having larger or smaller volumes.

The tank further comprises a first port 110 and a second port 112 through which fluid communication is established between the tank inner cavity and spaces outside the tank inner cavity. A discharge tube 113 extends from the first port into the tank inner cavity and terminates proximate a bottom of the tank inner cavity. Some embodiments of tanks comprise shells made of other materials, including but not limited to, other polymers, metals and metal alloys, fiberglass, elastomers, plastics and thermoplastics, and carbon fiber composites and other composite materials.

The wand 104 comprises an inlet 120, an outlet 122, a valve 124 and an additive reservoir 126, and is operationally coupled to the tank by the first hose 106. The inlet and the outlet are operationally coupled by a wand fluid path (not visible) that resides inside the wand. The valve is adapted to alternately change between a closed status, in which the valve is closed and fluid communication along the wand fluid path is interrupted, and an open status, in which the valve is open and fluid communication along the wand path is established or restored. The open status includes a spectrum of multiple positions or orientations, from only slightly open to full open. Accordingly, the valve is adapted to meter flow of fluid from relatively low flow rate and velocity to relatively high flow rate and velocity. The wand 104 of the first embodiment fluid spray device 100 is constructed of sections of ½ inch inside diameter schedule 40 polyvinyl chloride (PVC).

A discharge fluid path operationally couples the tank inner cavity 114 to the outlet 122 of the wand 104, the discharge fluid path passing through the discharge tube 113, the first port 110, the first hose 106, and the wand 126, With the valve 124 in the open status and sufficient positive gas pressure in a tank head space 115 above a tank liquid 116, the tank liquid is forced through the discharge fluid path to emerge from the outlet of the wand. The additive reservoir 126 is in fluid communication with the discharge fluid path such that a substance in the additive reservoir may be introduced into the discharge fluid path and subsequently discharged from the wand outlet 122. Fluid communication between the additive reservoir and the discharge fluid path may be interrupted by use of a reservoir valve 127.

The first hose 106 of the first embodiment fluid spray device is preferably five feet or more in length and more preferably between 25 feet and 50 feet. In some embodiments, the first hose can be fifty or more feet in length to enable spraying fluid at a location substantially distant from the tank 102. Where the first hose is less than five feet in length, the wand 104 is tethered so closely to the tank 102 that the fluid spray device can be relatively difficult and impractical to use. Conversely, even 50 feet of first hose is relatively easily handled and provides a user with mobility that is highly advantageous.

An air compressor on truck 140 supplies compressed air to the tank 102, the compressed air flowing through a truck pneumatic system and continuing through the second hose 108 and second port 112 into the tank inner cavity 114. The air compressor also supplies compressed air to operate pneumatic brakes on the truck. The second hose is operationally coupled to the truck pneumatic system through a quick disconnect coupler referred to in the art as a glad hand 142. A pressure regulator with gauge 144 monitors and regulates air pressure between the truck pneumatic system and the tank 102.

The second hose 108 is preferably eight feet or more in length, more preferably between eight feet and thirty five feet in length, and most preferably about 25 feet in length. With a second hose length of at least eight feet, the tank 102 can rest on the ground while the second hose couples the tank to a typical truck's pneumatic system glad hand coupler.

Pressure in the truck pneumatic system is about 150 psi and is typically adjusted downwardly by the pressure regulator to provide a head pressure in the tank head space 115 of about 90 psi. With about 15 liters of water and 90 psi gas pressure in the tank inner cavity 114, the fluid spray device 100 dispenses about 2.5 liters of water per minute. The first embodiment fluid spray system may operate at lower air pressure as well.

The first hose 106 and second hose 108 are high pressure hoses that are rated at 320 psi operating pressure and have inside diameters of ⅜ inch. Other embodiments use hoses having different inside diameters and different maximum operating pressures. The first and second hoses are coupled to the first 106 and second 108 ports with quick disconnect couplers comprising male and female quick disconnect fittings that are well know to persons of ordinary skill in the art.

The tank liquid 116 in the first embodiment fluid spray device 100 is water, the reservoir substance is detergent, and the device is typically used to wash the truck 140. Other tank liquids and reservoir substances are contemplated, and embodiments of the fluid spray device may be used for other purposes. With a head pressure of about 90 psi, the fluid spray device can discharge a powerful stream or spray that is well adapted to washing the truck, and addition of the reservoir substance (detergent) to the stream or spray enhances cleaning action. The valve 124 may be used to modulate flow through the fluid discharge path to provide a less powerful stream or spray, or to interrupt flow entirely.

After washing the truck 140, a rinsing agent may be placed in the additive reservoir 126 in order to enhance rinsing. The fluid spray device 100 may be operated without a tank liquid 116 and without dispensing a reservoir substance, in which case the fluid spray device discharges compressed air or other gas.

### A Second Embodiment Fluid Spray Device

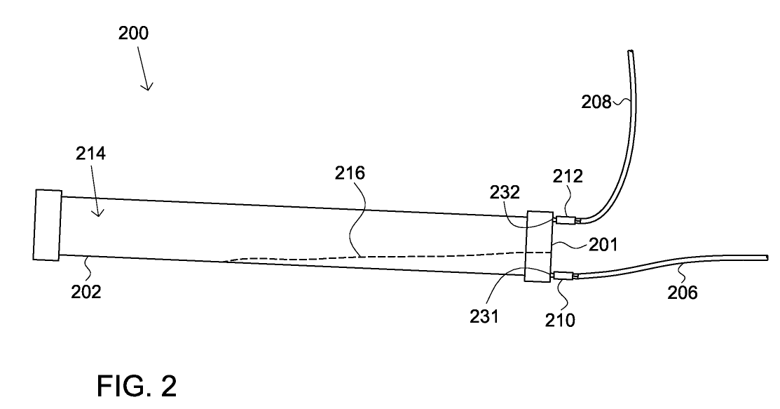

A second embodiment fluid spray device 200 is illustrated in FIG. 2. The second embodiment fluid spray device comprises a tank 202, a first hose 206, and a second hose 208. The tank comprises a first port 210 and a second port 212, and is adapted to hold about 180 psi gas pressure. The first hose extends from the first port to a wand (not shown), and the second hose extends from the second port to a truck, where the second hose is operationally coupled by a glad hand coupler to a truck pneumatic system. The wand of the second embodiment fluid spray device is generally similar to the wand of the first embodiment fluid spray device. The truck, glad hand coupler, and truck pneumatic system are not shown. The first port and the second port of the second embodiment are identical and interchangeable; the fluid spray device can be operated with the second hose coupled directly to the first port and the first hose coupled directly to the second port.

The tank 202 of the second embodiment further comprises a schedule 40 PVC cylinder having an inside diameter of about six inches and a length of about 15.2 cm, a length of about 183 cm, and an internal cavity 214 having a volume of about 33.2 liters. The cylindrical shape of the tank is particularly well adapted to mounting on or carrying in a truck bed, a tractor frame, or a trailer. The volume of over 30 liters is ample for many washing jobs, but does not require an impractically large tank.

Unlike the first embodiment, the second embodiment fluid spray device 200 does not include a discharge tube that extends from the first port for a substantial distance into the inner cavity 214 of the tank 202. Rather, the first port 210 and the second port 212 have a first internal terminus 231 and a second internal terminus 232, respectively, at about a periphery of the inner cavity disposed at a tank first end 201, and each of the first and second ports are in fluid communication with the inner cavity.

The fluid spray device 200 is typically operated in a first orientation or a second orientation. In its first orientation, the cylindrical tank 202 is oriented laying on its side and tilted downwardly toward the tank first end 201, and with the first port 210 residing at or near its bottom most position. As shown in FIG. 2, with only slight downward tilt of the tank toward the tank first end 201, the internal terminus 231 of the first port remains submerged beneath a surface of the tank liquid 216 with relatively little tank liquid residing in the tank. A person of ordinary skill in the art recognizes that the internal terminus of the first port should be submerged in the tank liquid in order for the tank liquid to exit through the first port.

Because the first port 210 and the second port 212 are identical and interchangeable, the first hose 206 and the second hose 208 can be interchanged. Accordingly, with the first hose coupled directly to the second port and the second hose coupled directly to the first port, the second embodiment fluid spray device 200 can be operated in a second orientation. In the second orientation, the tank 202 is oriented lying on its side with the second port residing at or near its bottom most position. So oriented, the internal terminus 232 of the second port can be submerged beneath the surface of the tank liquid 216 with relatively little tank liquid residing in the tank. The fluid spray device is not shown in the second orientation.

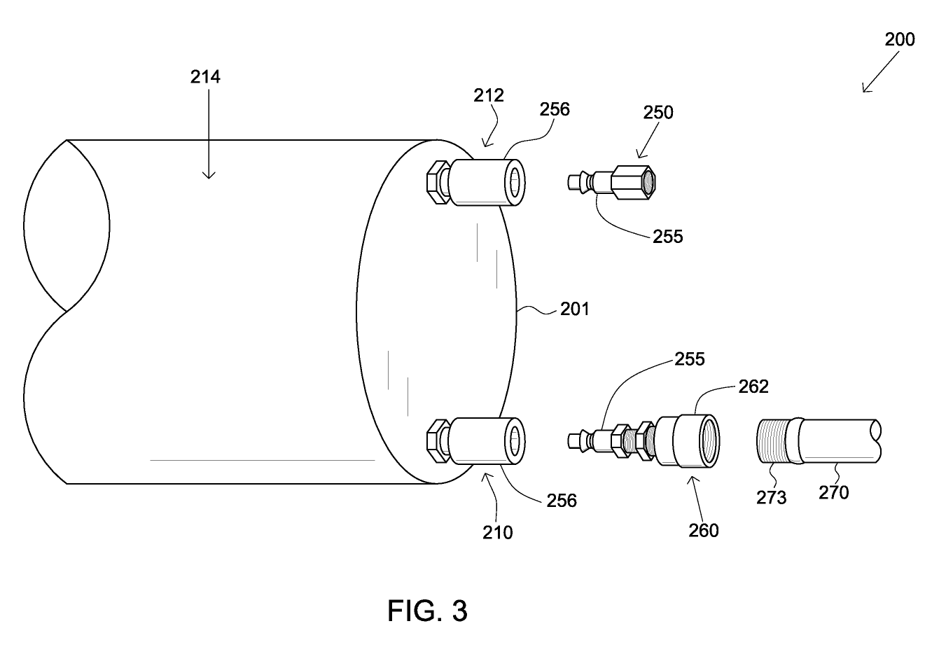

Liquid is added to the tank 202 of the second embodiment fluid spray device 200 through either of the first port 210 or the second port 212. Gas displaced by the liquid is vented through either the first port or the second port. Adding liquid to the tank is accomplished by use of a fluid fill adaptor 250 and a vent adaptor 260, illustrated in FIG. 3. The fluid fill adaptor and vent adaptor each comprise a male quick disconnect fitting 255 adapted to mate with either of two female quick disconnect fittings 256, the female quick disconnect fittings being components of the first port and the second port.

The fluid fill adaptor 260 further comprises a female garden hose fitting 262 adapted to mate with a male garden hose fitting 273. In typical use, the male garden hose fitting is threaded into the female garden hose fitting of the fluid fill adaptor, and the male quick disconnect fitting 255 of the fluid fill adaptor 260 is inserted into the female quick disconnect fitting 256 of one of the first port 210 and the second port 212. Thus configured, fluid can be added to the tank through a garden hose 270, the garden hose comprising the male garden hose fitting. In some embodiments, the fluid fill adaptor is coupled to a funnel or similar device through which liquid can be added to the tank.

Adding fluid to the tank 202 is facilitated by venting displaced gas through an other of the first port 210 and second port 210. The venting is typically accomplished by mating the male quick disconnect fitting 255 of the vent fitting 250 with the female quick disconnect fitting 256 of the other of the first port and the second port while fluid is added to the tank through the one of the first port and the second port.

The female quick disconnect fittings 256 of the second embodiment fluid spray device 200 blocks fluid communication therethrough when not mated to a complementary male quick disconnect fitting. Conversely, mating the male quick disconnect fitting 255 of the fluid fill adaptor 262 or the vent adaptor 250 with the female quick disconnect fitting 256 of the first port 210 or the second port 212 enables fluid communication through the first port or the second port.

### Alternative Embodiments and Variations

The various embodiments and variations thereof, illustrated in the accompanying Figures and/or described above, are merely exemplary and are not meant to limit the scope of the invention. It is to be appreciated that numerous other variations of the invention have been contemplated, as would be obvious to one of ordinary skill in the art, given the benefit of this disclosure. All variations of the invention that read upon appended claims are intended and contemplated to be within the scope of the invention.

For instance, in some embodiments the tank may be installed on or in a vehicle, rather than resting on the ground as shown in FIG. 1, and the tank may be plumbed into the vehicle pneumatic system without the use of a glad hand coupler. In some variations, herbicide or pesticide may be used as a reservoir substance, and the fluid spray device may be used to dispense a solution for killing plants or pests.

I claim:

1. A fluid spray device comprising:
a tank, the tank including a first fluid port and a second fluid port, at least one of the first fluid port and the second fluid port being adapted to admit a gas into the tank, and at least one of the first fluid port and the second fluid port being adapted to permit discharge of a liquid from the tank through the at least one of the first fluid port and the second fluid port;
a wand, the wand including;
a wand inlet;
a wand outlet, the wand inlet and the wand outlet being operationally coupled by a wand fluid path; and
a valve, the valve having a closed status that blocks fluid communication in a discharge fluid path and an open status that enables fluid communication in the discharge fluid path, the discharge fluid path extending from the tank to the wand outlet; and
a first hose, the first hose (i) having a length of five feet or more and (ii) residing in the discharge fluid path between the tank and the valve.

2. The fluid spray device of claim 1, further comprising an additive reservoir, the additive reservoir being adapted to dispense a reservoir substance into the discharge fluid path downstream from the tank.

3. The fluid spray device of claim 2, wherein the additive reservoir is adapted to dispense the reservoir substance into the wand fluid path.

4. The fluid spray device of claim 3, further comprising a second hose, the second hose including one or more quick disconnect fittings and a combined length of the first hose and the second hose is thirteen feet or more.

5. The fluid spray device of claim 4, wherein at least one of the one or more quick disconnect fittings is a glad hand fitting.

6. The fluid spray device of claim 5, wherein the second hose is coupled to the second fluid port by use of at least one of the one or more quick disconnect fittings and the first hose is coupled to the first fluid port.

7. The fluid spray device of claim 6, further comprising:
compressed air, the compressed air residing in the tank; and
aqueous liquid, the aqueous liquid residing in the tank.

8. The fluid spray device of claim 7, further comprising a reservoir substance, the reservoir substance residing in the additive reservoir.

9. The fluid spray device of claim 4, wherein the device does not include a gas compression means.

10. A fluid spray combination comprising:
a vehicle, the vehicle including an air compressor; and
the fluid spray device of claim 5, wherein the second hose is operationally coupled to the air compressor.

11. The fluid spray combination of claim 10, wherein:
the vehicle further comprises a vehicle glad hand fitting and a fluid path, the fluid path providing fluid communication between the air compressor and the glad hand fitting;
the air compressor provides compressed air for pneumatic brakes on the vehicle; and
the second hose is coupled to the vehicle glad hand fitting.

12. The fluid spray combination of claim 11, wherein the fluid spray device is adapted to (i) discharge four liters or more aqueous liquid from the wand outlet at a substantially constant pressure of about ten psi, (ii) discharge four liters or more aqueous liquid from the wand outlet at a substantially constant pressure of about 70 psi, and (iii) discharge four liters or more compressed air from the wand outlet at a substantially constant pressure of 70 psi.

13. A fluid spray device comprising;
a tank, the tank including:
a tank inner cavity, the tank inner cavity (i) being adapted to hold 90 psi or more air pressure, and (ii) having a volume in a range between about 4 liters and about 125 liters;
a tank inlet, the tank inlet being adapted to admit compressed air into the tank inner cavity;
a tank outlet, the tank outlet being adapted to permit discharge of a liquid from the tank inner cavity through the tank outlet;
a wand, the wand including a wand inlet and a wand outlet, the wand inlet and the wand outlet being operationally coupled by a wand fluid path; and
a valve, the valve having a first status that blocks fluid communication in a discharge fluid path and a second status that enables fluid communication in the discharge fluid path, the discharge fluid path operationally coupling the tank outlet to the wand outlet; and
a first hose, the first hose residing in the discharge fluid path between the tank and the valve.

14. The fluid spray device of claim 13, wherein the device does not include an air compressor.

15. The fluid spray device of claim 14, wherein the tank further comprises a PVC cylinder, and the inner cavity resides within the PVC cylinder and has a volume of 30 liters or more.

16. A method of using the fluid spray device of claim 14 comprising:
placing a volume of water in the tank inner cavity;
coupling the fluid spray device to a vehicle, the vehicle including an air compressor;
delivering compressed air from the air compressor to the tank;
discharging a volume of water from the wand outlet.

17. The method of claim 16, wherein the fluid spray device further comprises an additive reservoir, the additive reservoir (i) having a volume less than the inner cavity volume and (ii) being in fluid communication with the discharge fluid path.

18. The method of claim 17, further comprising:
placing a reservoir substance in the additive reservoir; and
discharging the reservoir substance from the wand outlet.

19. The method of claim 18, wherein the reservoir substance is a surfactant or a wax.

20. The method of claim 14, wherein the fluid spray device further comprises a glad hand fitting, and the coupling of the fluid spray device to the vehicle is through the glad hand fitting, and further comprising uncoupling the fluid spray device from the vehicle.
